(19) United States
(12) Patent Application Publication
(10) Pub. No.: US 2026/0077782 A1
(43) Pub. Date: Mar. 19, 2026

(54) Driver assistance method, control device, motor vehicle, storage medium, and server device for operation in the Internet

(71) Applicant: AUDI AG, Ingolstadt (DE)

(72) Inventors: Andreas Sebastian Binder, Hepberg (DE); Matthias Pfromm, Ingolstadt (DE)

(73) Assignee: AUDI AG, Ingolstadt (DE)

(21) Appl. No.: 19/332,822

(22) Filed: Sep. 18, 2025

(30) Foreign Application Priority Data
Sep. 19, 2024 (DE) 10 2024 126 920.0

(51) Int. Cl. B60W 50/14; B60W 50/00; B60W 50/08; G06T 13/00

(52) U.S. Cl. CPC B60W 50/14; B60W 50/082; G06T 13/00; B60W 2050/0026; B60W 2050/0028; B60W 2050/146; B60W 2540/215; G06T 2200/24

(57) ABSTRACT

A driver assistance method by a control device of a motor vehicle includes receiving surroundings data, which describe a current travel situation in a region around the motor vehicle; on basis of the received surroundings data, providing a vehicle surroundings model, which describes the current travel situation and surroundings of the motor vehicle; checking whether one of a plurality of driver assistance systems available to the motor vehicle meets an assistance criterion which specifies a minimum probability with which a driver assistance system will assist the driver in the current travel situation and in the surroundings of the motor vehicle. If a driver assistance system that meets the assistance criterion is available, the control device is configured to generate an information display signal, which describes a digital representation of a proposal to use the driver assistance system that meets the assistance criterion; and transmits the generated information display signal to the display device. The digital representation can be an avatar.

### CROSS-REFERENCE TO RELATED APPLICATIONS

This application claims the priority benefit of German Patent Application No. 10 2024 126 920.0 filed on Sep. 19, 2024, which is incorporated by reference herein in its entirety.

### BACKGROUND

### 1. Field

An invention relates to a driver assistance method, according to described examples. The invention additionally relates to a control device, a motor vehicle, a storage medium, and a server device for operation in the Internet, according to described examples.

### 2. Description of the Related Art

Current vehicles are generally equipped with numerous driver assistance systems. All of these driver assistance systems, such as adaptive cruise control, lane keeping, active front assistance systems (for example, safety systems), or parking assistants, have to be manually activated. Often, the useful areas in which these systems can be or should be used are not sufficiently known to the vehicle drivers. Or they are even used more or less incorrectly, i.e. in situations for which they are not specified. Furthermore, some vehicle drivers have inhibitions about activating driver assistance systems, above all those which actively engage in the vehicle control.

EP 3 620 319 A1 relates to a method for operating a virtual assistant for a motor vehicle. An avatar interface of the virtual assistant is presented to a user in the motor vehicle and a predefined set of accessible elements is provided for selection by the user, wherein the accessible elements comprise operating functions and/or information data. The method is characterized in that at least one user statement of the user is received via the avatar interface; a question-answer logic for determining at least one of the accessible elements is operated in the virtual assistant, which accessible elements are requested by the user using the at least one user statement; and the at least one identified accessible element is provided to the user.

A vehicle having a recommendation function for an advanced driver assistance system (ADAS) and a method for controlling the vehicle are known from US 2017/0267252 A1. The vehicle comprises a detection unit, which is configured to detect behavior information of a driver, and a controller, which is configured to determine a mode of an advanced driver assistance system (ADAS) that can be recommended for the driver based on the detected behavior information and to output the determined ADAS mode.

US 2023/303109 A1 describes a recommendation device, which detects a travel route of the vehicle driven by a target user; specifies one or more driver assistance functions recommended for use on the travel route and also recommended areas of use, in which the use of the driver assistance functions is recommended; evaluates a usage dataset of the target user with respect to the specified driver assistance functions; and outputs recommendation information to recommend: the driver assistance functions remaining after exclusion of the driver assistance functions for which an evaluation result of the usage dataset of the target user corresponds to a prescribed condition from the specified driver assistance functions; and the respective recommended areas of use of the driver assistance functions.

It is disadvantageous that these systems are not used or are not used in the specified useful areas, which often results in incorrect behavior, for example the use of an adaptive cruise control in city traffic.

### SUMMARY

One example object underlying the invention according to described examples is providing improved assistance for a driver when driving a motor vehicle.

The stated example object may be achieved in each case by the devices according to the examples of the invention and the method according to the examples of the invention, according to the respective independent claims. Advantageous refinements may be specified by the dependent claims.

The invention according to the examples is based on the concept of providing, during a journey of a motor vehicle, a vehicle surroundings model, which describes a current travel situation in which the motor vehicle is located, via surroundings data, thus via data which describe, for example, driving surroundings, driving parameters, and/or driving data during a journey. Proposals for situation-specifically suitable driver assistance systems for assisting the driver are to be determined on the basis of the ascertained vehicle surroundings model and these are proposed to the driver.

A driver who is not very familiar with the use of driver assistance systems or does not know them is thus not only guided to the use of driver assistance systems, but rather can also improve their driving ability with respect to the use of driver assistance systems. The above-described disadvantages are reduced or even eliminated. The proposals for situation-suitable driver assistance systems are presented to the driver via a display device, thus via a display unit, because of which the driver assistance method can also be referred to as a method for operating a display device.

The driver assistance method according to the examples of the invention is carried out by a control device of a motor vehicle. A control device is understood as a device or a device component which is configured to receive and analyze signals and to generate control signals and transmit them to other devices or device components. For this purpose, the control device can comprise a receiver module and/or a transmitter module, as well as one or more microprocessors. The control device can be configured, for example, as a controller or control chip.

The control device receives surroundings data, which describe a current travel situation in a predetermined region around the motor vehicle. The surroundings data can be received, for example, from a sensor unit of the motor vehicle, thus from a device, a device group, or a device component which comprises at least one sensor. Alternatively or additionally, the control device can receive the surroundings data via motor vehicle-to-motor vehicle communication, via motor vehicle-to infrastructure communication, and/or, for example, from an Internet connection from a motor vehicle-external data server.

The surroundings data can describe, for example, a planned travel route of the motor vehicle on which the motor vehicle is underway, operating data of the motor vehicle, map data, navigation data, data on the current traffic situation, and/or data about other road users or obstacles established in the vicinity of the motor vehicle. Optionally, the surroundings data can additionally or alternatively also describe driver data, thus data which describe a behavior of the driver during the journey.

The received surroundings data describe a current travel situation in a predetermined region around the motor vehicle. The predetermined region can be defined, for example, via standard setting as a region of five kilometers. The control device provides a vehicle surroundings model, which describes the current travel situation and the surroundings around the map vehicle, on the basis of the received surroundings data. The vehicle surroundings model is thus a digital model in which, for example, a position of the motor vehicle, driving data such as the speed of the motor vehicle, navigation data on a planned travel route, map data on the surroundings, information on the route and on other motor vehicles may be incorporated.

The control device checks whether one or more driver assistance systems of the motor vehicle meet a predetermined assistance criterion. The predetermined assistance criterion specifies a minimum probability with which a driver assistance system will assist the driver in the current travel situation and in the current area of use of the motor vehicle—thus in the current overall situation in which the motor vehicle is located. The assistance criterion can therefore also be referred to as a suitability criterion, since it is intended for a suitable driver assistance to be selected for the corresponding travel situation.

In an example, the vehicle surroundings model can describe, for example, a dynamic list of states of the vehicle surroundings of the motor vehicle and correspondingly suitable driver assistance systems. In another, more advantageous example, the vehicle surroundings model can enable a scenario analysis, i.e. beyond the actual travel situation, also carry out a prediction as to how the travel situation will presumably develop, for example, on the next two kilometers, the next five kilometers, or the next ten kilometers.

If the motor vehicle is located on the freeway, for example, and the traffic flows freely, active cruise control (ACC), thus an adaptive cruise control, can meet the predetermined assistance criterion. However, if the motor vehicle is currently located on a rural road, the checking procedure can have the result that the adaptive cruise control does not meet the predetermined assistance criterion. If the vehicle surroundings model describes that the motor vehicle is located at the end of a navigation route and in a residential area, for example, a parking aid as a driver assistance system can likewise meet the predetermined assistance criterion.

If a driver assistance system meets the predetermined assistance criterion, the control device generates an information display signal which describes a digital visual representation of a proposal for the use of this driver assistance system. In the examples, the control device can thus generate, for example, a text message or a visual representation of the proposal of the adaptive cruise control or parking aid. The control device transmits the generated information display signal to the display device.

A display device is understood as a display unit, thus a device group, a device, or a device component which is configured to output graphic or visual information. The display device can have a display screen or be embodied as a display screen for this purpose.

The above-described examples may result in advantages.

The digital representation of the proposal can be a digital animation of a predetermined graphic element. The method can therefore also be referred to as a method for providing a digital animation of a predetermined graphic element. A digital animation of a predetermined graphic element, which can also be referred to as display content, is understood as the display of variable information which is output visually. Such an animation can be an avatar. An avatar is a virtual being which is displayable on a display screen, for example, and can be configured for communication by natural language with a natural person, and which can also be referred to as a digital representation of a being. An avatar can therefore also be referred to as a digital character. If the graphic element is, for example, a representation of a small robot, a moving robot having expressions and body language can be animated and displayed by its animation.

A digital animation, in particular an avatar, has the advantages that information content can be conveyed so it is better understandable. In particular, an avatar represents a digital character, through the personal manner of which the display and presentation of information can be perceived, absorbed, and understood much better.

In one example of the driver assistance method according to the invention, the control device can carry out a scenario analysis. For this purpose, the control device can classify the current travel situation on the basis of the provided vehicle surroundings model into one of multiple predetermined driving scenarios, for example into the driving scenarios “freeway journey”, “journey on rural road”, “journey in residential area”, “congestion scenario”, “parking scenario”, “transverse control/lane keeping scenario”, or “long distance journey on the freeway”. Such classifications describe different areas of use.

The control device then selects the driver assistance system on the basis of this predetermined driving scenario. This example also includes an additional prediction of the development of the current travel situation and the driver assistance system can be selected which is consistently the most efficient one.

Such a scenario analysis can be carried out with the aid of a neural network. Here, the control device can transmit the provided surroundings data to a deep learning engine. A deep learning engine (“deep learning unit”) is a device, a device component, or a program which can apply so-called deep learning (so-called machine learning) to a large amount of data. In other words, the deep learning engine is a highly-developed unit for carrying out deep learning, thus an implementation of artificial intelligence. In other words, both artificial intelligence as machine learning and deep learning are implementable by the deep learning engine. The deep learning engine can be configured and/or embodied, for example, as a deep artificial neural network. In other words, the deep learning engine can be configured, by a method of machine learning, to evaluate a large number of experiential values and/or training data, which can also be referred to as a training dataset, or a dataset according to a predetermined algorithm and on the basis of the already stored large number of experiential values, for example via a logic contained therein, for example a correlation. In this way, further logical links can also be created in the deep learning engine.

Experiential values or training data can then be statistically compiled here, for example, for a large number of surroundings data—or also a large number of different travel situations described by surroundings data—and then to form driving scenarios and driver assistance systems suitable therefor.

In this example of the method according to the invention, the control device can operate the deep learning engine so that, by way of the deep learning engine, driving scenarios and driver assistance systems suitable therefor are statistically compiled for a large number of surroundings data or for a large number of different travel situations described by surroundings data.

The control device can furthermore operate the deep learning engine in order to process the travel situations described by the provided surroundings data or by the provided surroundings data by the deep learning engine and in this way to ascertain a scenario analysis. The scenario analysis comprises in this case a probability with which the motor vehicle will be located in a specific driving scenario.

If the probability that the motor vehicle will be located in the driving scenario exceeds a predetermined threshold value, the control device defines the driving scenario by use of the deep learning engine, for example, predicts the driving scenario, and thus ascertains the suitable driver assistance system.

By way of this example of the method according to the invention, a suitable driver assistance system can be selected even with a large number of previously unknown travel situations.

In a further example of the driver assistance method according to the invention, it can be provided that the control device only generates the information display signal if the provided vehicle surroundings model describes that the current travel situation will be maintained over a predetermined minimum period of time. In such an assessment of the continuation of the scenario, a particularly precise selection of the suitable driver assistance system can thus take place, in other words, depending on the ascertained scenario and the weighted continuity.

In a further example, the control device can receive an operating signal which can describe a user wish of a user of the motor vehicle to activate the proposed driver assistance system, and activate the proposed driver assistance system depending on the received operating signal. The user thus once again has a possibility in this case, after they have learned which driver assistance system is particularly suitable in their current travel situation, to confirm and thus approve the use of the driver assistance system.

Alternatively thereto, it can be provided that the control device immediately activates the selected driver assistance system. If the control device also informs the user immediately about the automatic activation in this case, for example, via the display device, the user of the motor vehicle is aware and experiences in a didactically valuable manner how the driver assistance system functions and how it acts.

In a further example, it can be provided that the digital representation can describe a digital logbook for the motor vehicle or a part thereof. Also in the parked state, the user can thus look up before or after the journey which driver assistance systems are available, optionally, for example, which driver assistance systems were used during a journey, and/or can inform themselves in advance before a journey. The driver is thus already assisted before the journey and also after the journey in the learning process.

For applications or application situations which can result in the method and are not explicitly described here, it can be provided that according to the method an error message and/or a prompt to input user feedback is output and/or a standard setting and/or a predetermined initial state is set.

The invention according to the examples also includes the control device for the motor vehicle. The control device can have a data processing device or a processor unit (processor circuit), which is configured to carry out the method according to the examples of the invention. The processor unit can have for this purpose at least one microprocessor and/or at least one microcontroller and/or at least one FPGA (Field Programmable Gate Array) and/or at least one DSP (Digital Signal Processor). In particular, a CPU (Central Processing Unit), a GPU (Graphical Processing Unit), or an NPU (Neural Processing Unit) can each be used as the microprocessor. Furthermore, the processor unit can have program code which is configured, when it is executed by the processor unit, to carry out the method according to the examples of the invention. The program code can be stored in a data memory of the processor unit. The processor unit can be based, for example, on at least one circuit board and/or on at least one SoC (System on Chip).

The example object stated above is also achieved by a motor vehicle which has the control device according to the examples of the invention. The motor vehicle according to the examples of the invention may be configured as an automobile, in particular as a passenger vehicle or truck, or as a bus or motorcycle.

As a further solution, the invention according to the examples also comprises a computer-readable storage medium, comprising program code, which, when it is executed by a computer or a computer network, causes it to carry out the method according to the examples of the invention. The storage medium can be at least partially provided as a nonvolatile data memory (for example, as a flash memory and/or as an SSD (solid-state drive)) and/or at least partially as a volatile data memory (for example, as a RAM (random access memory)). The storage medium can be arranged in the computer or computer network. The storage medium can also be operated, for example, as a so-called app store server and/or cloud server in the Internet, however. A processor circuit having, for example, at least one microprocessor can be provided by the computer or computer network. The program code can be provided as binary code and/or as assembler code and/or as a source code of a programming language (for example, C) and/or as a program script (for example, Python). The computer-readable storage medium can alternatively be implemented by a signal having computer-readable data, for example a time-variant voltage signal and/or a radio signal.

The invention according to the examples also includes refinements of the motor vehicle according to the examples of the invention, the control device according to the examples of the invention, and the storage medium according to the examples of the invention, which have features as have already been described in conjunction with the refinements of the method according to the examples of the invention. For this reason, the corresponding refinements of the motor vehicle according to the examples of the invention, the control device according to the examples of the invention, and the storage medium according to the examples of the invention are not described once again here.

The invention also comprises the combinations of the features of the described examples. The invention thus also comprises implementations which each have a combination of the features of several of the described examples, if the examples have not been described as mutually exclusive.

### BRIEF DESCRIPTION OF DRAWINGS

Examples of the invention are described hereinafter. In the figures:

FIG. 1 shows a schematic representation of a first example of a method according to the invention;

FIG. 2 shows a schematic representation of a second example of a method according to the invention;

FIG. 3 shows a schematic representation of a third example of a method according to the invention for recommending one or more driver assistance systems;

FIG. 4 shows a further schematic representation of the third example of the method according to the invention for activating one or more driver assistance systems;

FIG. 5 shows a schematic representation of an example of a driver assistance display, for example a digital logbook.

### DESCRIPTION

The examples explained hereinafter are examples of the invention. In the examples, the described components of the examples each represent individual features of the examples of the invention to be considered independently of one another, which each also refine the examples of the invention independently of one another. The disclosure is therefore also to comprise combinations of the features of the examples other than those shown. Furthermore, the described examples can also be supplemented by further features of the examples of the invention which have already been described.

### In the Figures, Identical Reference Signs Each Identify Functionally-identical Elements.

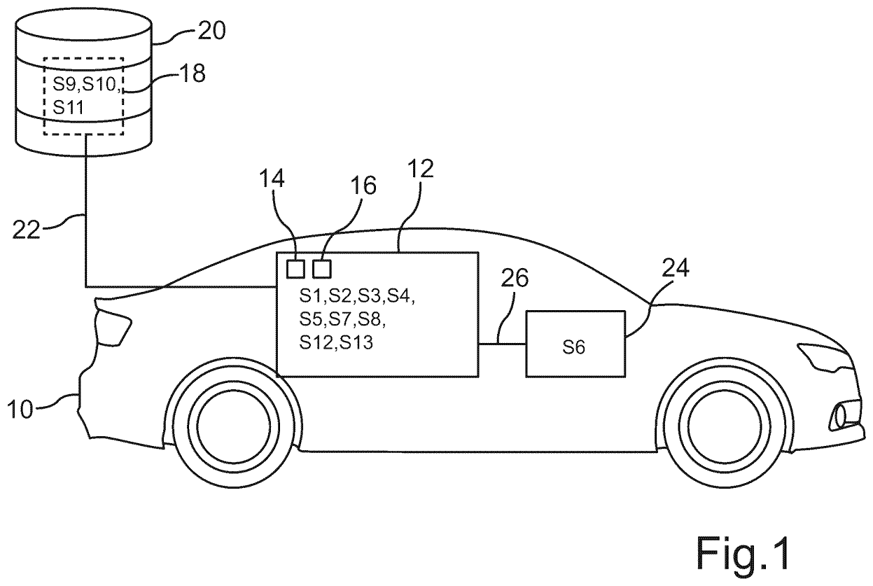

FIG. 1 shows an example of a method according to the invention and an example of devices according to the invention. For this purpose, FIG. 1 shows a motor vehicle 10 configured, for example, as a passenger vehicle, having a control device 12 configured for example, as a controller. The control device 12 can have at least one processor unit 14 and/or a data memory 16.

FIG. 1 also shows an optional deep learning engine 18, which can be located, for example, at the motor vehicle-external data server 20. In such a constellation, the communication between control device 12 and deep learning engine 18 can take place via a data communication connection 22, which can be a wired data communication connection, for example an Internet connection or mobile wireless connection. Alternatively, the deep learning engine 18 can be a component of the control device 12.

In the example of FIG. 1, a deep learning engine 18 is shown as a component of the control device 12. Alternatively, the deep learning engine 18 can be integrated in a server device 20 shown as an example, however, and can communicate wirelessly with the control device 12.

Training data or experiential values, using which such a deep learning engine 18 can be trained, can be compiled as an artificial neural network and can originate, for example, from a database. In an example, such data on surroundings data and travel situations can be used/can have been used in a number of >1000, in particular >10,000, for training the deep learning engine 18, wherein the training data were detected over a predetermined observation period of time. Such a dataset can be referred to as a big data dataset.

Each experiential value can in this case be, for example, a combination of surroundings data or a travel situation described by surroundings data and the corresponding driving scenario, for example also for a driver assistance system suitable for the driving scenario. An experiential value is thus understood as a value or a specification which, for example, based on empirical measurements or studies, makes a statement about whether the driver assistance system is suitable in the driving scenario.

The experiential value can thus be, for example, a numeric value or an assignment value. An experiential value is also understood as a functional dependence or a functional assignment which makes a statement about whether or for which surroundings data or for which travel situation a driving scenario applies and which driver assistance system is suitable in this driving scenario. An experiential value can therefore, in other words, also be understood as a rule based on numeric values for the assignment.

The motor vehicle 10 of FIG. 1 additionally has a display device 24, which can be configured, for example, as a center display or display of the center console. The communication between control device 12 and display device 24 can take place, for example, via a wired data communication connection 26, for example a data BUS of the motor vehicle 10.

In the example of FIG. 1, the motor vehicle 10 can be underway, for example, on a rural road. The driver can be guided from a starting point to their destination assisted by a navigation device. The motor vehicle 10 can be equipped with multiple driver assistance systems, for example, among others, an active front assistant, i.e. a frontal collision assistant which monitors the traffic in front of the motor vehicle 10 for a possible collision risk and assists the driver in multiple steps. The motor vehicle 10 can additionally be equipped with an adaptive cruise control and a parking aid.

The control device 12 can receive (S1), for example, data from the motor vehicle sensor system as surroundings data, and traffic data from the server device 20, which can describe, for example, a current congestion volume. The control device 12 can acquire the latter, for example, from a motor vehicle-external data source, for example from an infrastructure or a data server for traffic data. The surroundings data can additionally or alternatively be retrieved or received, for example, from a navigation device of the motor vehicle 10 and can describe map data, for example. For example, the received surroundings data can describe that the motor vehicle 10 is moving.

In S2, the control device 12 provides the vehicle surroundings model, which can describe a route section on the very heavily traveled rural road; the motor vehicle 10 on the basis of its travel data, for example movement direction, geoposition, and speed; and for example also data of other motor vehicles, in particular on their geopositions (S2). It can be stored in the control device 12 as a predetermined assistance criterion, for example, that a driver assistance system is suitable if it matches with the type of the route section, thus with the journey on the rural road, and if it is reasonable, for example, with a minimum probability of 80 percent in the case of the current traffic volume. In S3, the control device 12 can check and thereupon establish that the adaptive cruise control is not reasonable on this rural road, nor is the parking aid. In the check S3 of the active front assistant, however, it can result that it is a reasonable assistance on this rural road. In the example of FIG. 1, the driver of the motor vehicle 10 can be inexperienced, for example, with respect to driver assistance systems, and currently may not have the active front assistant switched on. Since the active front assistant meets the predetermined assistance criterion in the example, the control device 12 generates an information display signal in S4, which can describe as a digital representation an animated avatar, which, for example, supplemented by the display of the text or by the output of a speech message, can propose switching on the active front assistant to the driver. In S5, the control device 12 transmits the generated information display signal to the display device 24, and in S6, the display device 24 displays the avatar.

In the case of the optional use of the deep learning engine 18, the control device 12 transmits in S7 the provided surroundings data to the deep learning engine 18. In particular upon the use of a deep learning engine 18, it can be provided that the deep learning engine 18 can be trained using fleet data or can also process this, and/or that the transmitted surroundings data comprise fleet data. Fleet data are understood here as the surroundings data which are for example bundled together from a large number of motor vehicles.

In S8, the control device 12 operates the deep learning engine 18 such that it statistically compiles driving scenarios and driver assistance systems suitable therefor for a large number of surroundings data and/or travel situations described by surroundings data. In addition, the control device 12 operates the deep learning engine 18 in this optional configuration (S8), so as to process (S9) the provided surroundings data or the current travel situation described by surroundings data and to ascertain (S10) a scenario analysis. This scenario analysis can then comprise, for example, a prediction of the further development of the motor vehicle movements. In addition, the control device 12 can operate (S8) the deep learning engine 18 so as to establish (S10) the current driving scenario on the basis of this scenario analysis, and thus to select (S11) the most suitable driver assistance system. The deep learning engine 18 can orient itself here to the predetermined assistance criterion.

If it is provided that the control device 12 only has the proposal displayed by the display device 24 if the current travel situation is maintained over a predetermined minimum period of time, the control device 12 can establish, for example, on the basis of the navigation data whether the journey via the rural road will still continue over a predetermined minimum period of time. In a further example, the driver can select the adaptive cruise control in the menu, for example, whereupon the control device 12 can propose that the use of this driver assistance system on the rural road is not reasonable, but that, for example, the travel route leads in approximately 30 minutes to a freeway, where it then can be reasonably used. Alternatively, the condition of maintaining the current travel situation over the predetermined minimum period of time can also be included as a specification in the predetermined assistance criterion.

In another example, the driver can already be underway on the freeway, but has to exit the freeway again at the next exit 500 meters after joining, however. The control device 12 can then, for example, establish via the navigation data that the use of the adaptive cruise control is not worthwhile and accordingly display a proposal via the display screen.

The driver assistance system thus checks whether the conditions are favorable for using a specific driver assistance system. In another example, the motor vehicle 10 can already be located in a residential area and can drive into the road of the travel destination. The proposal of a parking aid is reasonable here.

In a further optional configuration, the control device 12 and/or the deep learning engine 18 can learn, for example, that the driver of the motor vehicle 10, for example, always switches on a 3D camera of the motor vehicle in an angled courtyard entry, and in future it can be provided that the control device 12 in future automatically switches on the 3D camera as soon as the motor vehicle 10 is located in a courtyard entry.

In a further example, it can optionally be provided that the control device 12 receives (S12) an operating signal, for example, from a press-turn controller of the motor vehicle in the center console, which describes the user wish of the user of the motor vehicle 10 such that the user adopts the proposal and confirms the activation of the proposed driver assistance system. In S13, the control device 12 can then activate the corresponding driver assistance system.

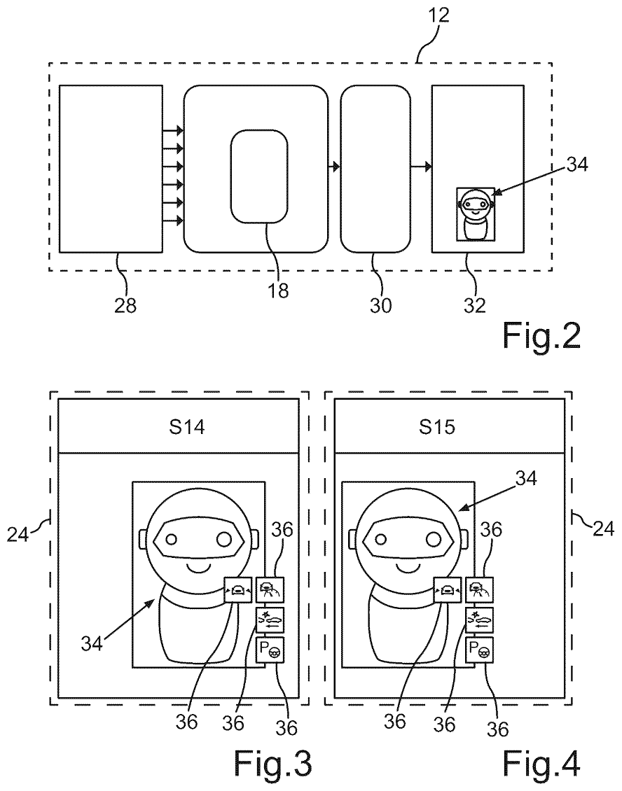

FIG. 2 shows a method and/or a system description according to a second example. In the central question of how the system, thus the control device 12, can assist the driver suitably for the situation, the input data 28, thus surroundings data which can optionally comprise fleet or swarm data of many motor vehicles, can be subjected to a classification or scenario classification, for example with a weighting and/or continuity, for example by the control device 12 and/or a deep learning engine 18, or by a deep learning engine 18 which can be integrated in the control device 12. The classification or scenario classification can be trained via labeled data and/or swarm data for this purpose.

A part of the control device 12, which can also be referred to as the driver assistance manager 30, can carry out a driver assistance system assessment, for example with a selection of the driver assistance system; and finally the driver assistance recommendation and/or driver assistance activation 32 can take place.

The input data 28 can comprise: The vehicle surroundings model, location information, information on environmental conditions (such as day and night), navigation data, driving dynamics data (for example from the steering), and/or driver data. Additionally or alternatively, the surroundings data can comprise data mentioned further above.

During the driver assistance recommendation 32 and the optional driver assistance activation 32, an avatar 34 can present the proposal, and can also directly activate the driver assistance system, optionally only after confirmation by the user. In other words, the driver assistance communication takes place here via the avatar 34 for example.

FIG. 3 shows a configuration of a display on the display device 24, according to an example. The digital representation can be configured in the form of an avatar 34, which can be in the form, for example, of a small, animated robot. FIG. 3 shows here the moment during a driver assistance recommendation S14, and in the example animation small display fields 36 can show specific symbols of the recommended driver assistance systems. In FIG. 4, it is then shown as an example in S15 how it is represented that a driver assistance system is activated (optionally confirmed activation). The symbols on the display fields 36 for the different driver assistance systems can then, for example, be displayed in a different color than in the driver assistance recommendation S14. If the driver assistance systems are recommended (S14, FIG. 3), the symbols can be colored yellow, for example, and after activation (S15, FIG. 4), for example, as green symbols.

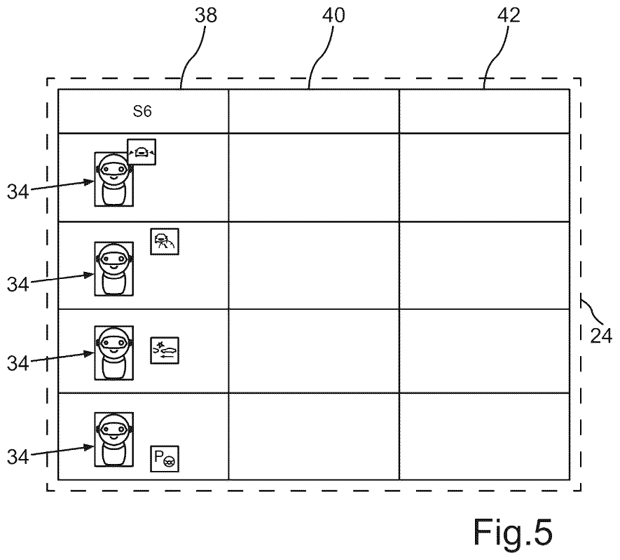

FIG. 5 shows the digital representation of a digital logbook in which in a first column 38, the animation of the avatar 34 for the individual driver assistance system proposals can be displayed, in the example of FIG. 5 for four different driver assistance systems. The left column thus shows the possible display S6. In the middle column 40 of the digital logbook, the designation of the corresponding driver assistance system can be shown, for example—from top to bottom—lane keeping, adaptive cruise control, active front assistant, parking assistant plus. In the column 42, a corresponding description of the respective driver assistant can then be displayed, for example that the lane keeping assists by steering interventions and helps to largely guide the motor vehicle 10 in the lane center. The digital logbook can then be called up, for example, during the journey if the driver wishes to look up what the symbols of the driver assistance proposals mean.

Overall, the examples show how a driver assistance system manager based on a digital representation, for example an avatar, can be provided.

Based on the concept of using avatars for communication with the motor vehicle and/or for setting vehicle functions, an avatar can also be used here. The avatar is controlled in this case, inter alia, via a driver assistance manager and reasonable driver assistance systems are proposed/displayed suitably for the situation and optionally directly activated (or confirmed as activated). The avatar proposes the activation of an assistance system reasonable in the current traffic situation to the driver and assists them in the activation thereof, or alternatively takes over the activation when it has been confirmed by the driver.

In other words, the avatar proposes the activation of an assistance system reasonable in the current traffic situation to the driver and assist the driver in the activation thereof or alternatively takes over the activation when it has been confirmed by the driver.

In a further technical implementation, this can be configured as follows, see also FIG. 1 and FIG. 2 in this regard:
1. Vehicle input data are incorporated in the algorithm, such as the vehicle surroundings model including, for example, location information, environmental conditions (for example day/night, weather), navigation data (to predict the further driving route), driving dynamics data (steering, v and/or a), and driver data (cf. driver observation camera).
2. These input data are for example incorporated into a pre-trained AI-based classification or scenario classification. This AI (artificial intelligence) can classify the current scenario based on the input data. (In the best case a further prediction can also be included with this therein, i.e. how the scenario will develop further). In this case, the pre-training of the AI for example takes place by labeled data, i.e. the situations are labeled in which the various driver assistance systems are to be used according to useful areas. Or the possibility continues to exist of recognizing the use of the driver assistance systems by swarm data, checking it for plausibility, and training the AI or the neural network accordingly. Alternatively, there is also the classic analytical method of identifying the current scenario by scenario analysis or situation analysis and predicting a further development of the scenario (for example using the current route data of the navigation). In summary, it is ascertained in this step in which driving scenario/travel situation the motor vehicle is currently located, including an assessment or weighting to what extent the scenario will continue, or whether it will change/further develop (cf. prediction by active route data of the navigation guidance).
3. Based on this recognized driving scenario and the weighted continuity, one matching or multiple matching driver assistance systems can be determined within the driver assistance manager (“DAS manager”).
4. The determined driver assistance system or the determined driver assistance systems is/are now proposed/displayed or directly activated (or confirmed as activated) by use of the avatar to the driver.

Example Explanation of the Method or Algorithm:
If a freeway journey or rural road journey with further long distance journey is recognized (for example recognizable via an active route guidance of the navigation)→output/activation of adaptive cruise control via the avatar; and/or
If a freeway journey or rural road journey with possible risk of congestion or risk of frontal collision is recognized:
additional output/activation of active front assistant via the avatar (cf. protection from frontal collision accidents); and/or
If lanes are present→output/activation of lane keeping via the avatar; and/or
If one is located in the city or the navigation destination is nearby→output/activation of parking assistant plus via the avatar.

According to an example, a driver assistance method causes a control device of a motor vehicle to execute a process to receive surroundings data, which describe a current travel situation in a region around the motor vehicle; on basis of the surroundings data, provide a vehicle surroundings model, which describes the current travel situation and surroundings of the motor vehicle; check whether at least one driver assistance system among driver assistance systems of the motor vehicle meets an assistance criterion which specifies a minimum probability with which the at least one driver assistance system will assist a driver of the motor vehicle in the current travel situation and in the surroundings of the motor vehicle; and if the at least one driver assistance system meets the assistance criterion, generate an information display signal, which describes a digital representation of a proposal to use the at least one driver assistance system as a proposed driver assistance system, and transmit the information display signal to a display device. In an example, the process by the control device is to further classify the current travel situation on basis of the vehicle surroundings model into at least one driving scenario among multiple driving scenarios, select the proposed driver assistance system on basis of the at least one driving scenario, and generate the information display signal if the vehicle surroundings model describes that the current travel situation classified will be maintained over a minimum period of time.

One possible representation of the driver assistance recommendation or a driver assistance activation or confirmed activation is shown in FIG. 3 and FIG. 4.

A schematic representation of a driver assistance recommendation and/or driver assistance activation, thus example schematic implementation of the display of a selection of various driver assistance systems, is shown in FIG. 4.

FIG. 5 shows a schematic representation of possible driver assistance displays using the avatar.

A description has been provided with particular reference to examples, but it will be understood that variations and modifications can be effected within the spirit and scope of the claims, which may include the phrase “at least one of A, B and C” as an alternative expression that refers to one or more of A, B or C, contrary to the holding in Superguide v. DIRECTV, 358 F3d 870, 69 USPQ2d 1865 (Fed. Cir. 2004).

1. A driver assistance method by a control device of a motor vehicle comprising:
by the control device configured to execute a process to
receive surroundings data, which describe a current travel situation in a region around the motor vehicle,
on basis of the surroundings data, provide a vehicle surroundings model, which describes the current travel situation and surroundings of the motor vehicle,
check whether at least one driver assistance system among driver assistance systems of the motor vehicle meets an assistance criterion which specifies a minimum probability with which the at least one driver assistance system will assist a driver of the motor vehicle in the current travel situation and in the surroundings of the motor vehicle,
if the at least one driver assistance system meets the assistance criterion,
generate an information display signal, which describes a digital representation of a proposal to use the at least one driver assistance system as a proposed driver assistance system, and
transmit the information display signal to a display device.

2. The driver assistance method according to claim 1, wherein the digital representation describes a digital animation of at least one graphic element, among graphic elements, including an avatar.

3. The driver assistance method according to claim 1, wherein the process by the control device is to further:
classify the current travel situation on basis of the vehicle surroundings model into at least one driving scenario among multiple driving scenarios, and
select the proposed driver assistance system on basis of the at least one driving scenario.

4. The driver assistance method according to claim 3, wherein the vehicle surroundings model is a plurality of vehicle surroundings models and the process by the control device is to further:
transmit the plurality of vehicle surroundings models to a deep learning engine such that the deep learning engine operates to,
statistically compile driving scenarios and driver assistance systems suitable for the driving scenarios for a plurality of vehicle surroundings of the motor vehicle or for a plurality of different driving situations, described by the plurality of vehicle surroundings models;
process a plurality of travel situations and vehicle surroundings of the motor vehicle described by the plurality of vehicle surroundings models to ascertain a scenario analysis among scenarios, wherein the scenario analysis comprises a probability with which the motor vehicle will be located in a specific driving scenario among the scenarios; and
if the probability that the motor vehicle will be located in the specific driving scenario exceeds a threshold value, establish the specific driving scenario on basis of the scenario analysis to ascertain the proposed driver assistance system.

5. The driver assistance method according to claim 1, wherein the control device generates the information display signal if the vehicle surroundings model describes that the current travel situation will be maintained over a minimum period of time.

6. The driver assistance method according to claim 1, wherein the process by the control device is to further:
receive an operating signal, which describes a user input by a user of the motor vehicle to activate the proposed driver assistance system, and
activates the proposed driver assistance system depending on the operating signal received.

7. The driver assistance method according to claim 1, wherein the digital representation describes a digital logbook or a part of the digital logbook.

8. A control device comprising:
at least one processor configured to execute a process to,
receive surroundings data, which describe a current travel situation in a region around a motor vehicle,
on basis of the surroundings data, provide a vehicle surroundings model, which describes the current travel situation and surroundings of the motor vehicle,
check whether at least one driver assistance system among driver assistance systems of the motor vehicle meets an assistance criterion which specifies a minimum probability with which the at least one driver assistance system will assist a driver of the motor vehicle in the current travel situation and in the surroundings of the motor vehicle,
if the at least one driver assistance system meets the assistance criterion,
generate an information display signal, which describes a digital representation of a proposal to use the at least one driver assistance system as a proposed driver assistance system, and
transmit the information display signal to a display device.

9. The control device according to claim 8, wherein the vehicle surroundings model is a plurality of vehicle surroundings models and the control device is further configured to:
transmit the plurality of vehicle surroundings models to a deep learning engine such that the deep learning engine operates to,
statistically compile driving scenarios and driver assistance systems suitable for the driving scenarios for a plurality of vehicle surroundings of the motor vehicle or for a plurality of different driving situations, described by the plurality of vehicle surroundings models;
process a plurality of travel situations and vehicle surroundings of the motor vehicle described by the plurality of vehicle surroundings models to ascertain a scenario analysis among scenarios, wherein the scenario analysis comprises a probability with which the motor vehicle will be located in a specific driving scenario among the scenarios; and
if the probability that the motor vehicle will be located in the specific driving scenario exceeds a threshold value, establish the specific driving scenario on basis of the scenario analysis to ascertain the proposed driver assistance system.

10. A motor vehicle, comprising:
a control device including at least one processor configured to execute a process to,
receive surroundings data, which describe a current travel situation in a region around a motor vehicle,
on basis of the surroundings data, provide a vehicle surroundings model, which describes the current travel situation and surroundings of the motor vehicle,
check whether at least one driver assistance system among driver assistance systems of the motor vehicle meets an assistance criterion which specifies a minimum probability with which the at least one driver assistance system will assist a driver of the motor vehicle in the current travel situation and in the surroundings of the motor vehicle,
if the at least one driver assistance system meets the assistance criterion,
generate an information display signal, which describes a digital representation of a proposal to use the at least one driver assistance system as a proposed driver assistance system, and
transmit the information display signal to a display device.

11. The motor vehicle according to claim 10, wherein the vehicle surroundings model is a plurality of vehicle surroundings models and the control device is further configured to:
transmit the plurality of vehicle surroundings models to a deep learning engine such that the deep learning engine operates to,
statistically compile driving scenarios and driver assistance systems suitable for the driving scenarios for a plurality of vehicle surroundings of the motor vehicle or for a plurality of different driving situations, described by the plurality of vehicle surroundings models;
process a plurality of travel situations and vehicle surroundings of the motor vehicle described by the plurality of vehicle surroundings models to ascertain a scenario analysis among scenarios, wherein the scenario analysis comprises a probability with which the motor vehicle will be located in a specific driving scenario among the scenarios; and
if the probability that the motor vehicle will be located in the specific driving scenario exceeds a threshold value, establish the specific driving scenario on basis of the scenario analysis to ascertain the proposed driver assistance system.
